(19) United States
(12) Patent Application Publication
(10) Pub. No.: US 2016/0028290 A1
(43) Pub. Date: Jan. 28, 2016

(54) Systems for Generating Electrical Energy

(71) Applicants: Guifre Guillen Tort-Ortiz, San Juan, PR (US); Antonio Jose Roig-Pagan, Ponce, PR (US)

(72) Inventors: Guifre Guillen Tort-Ortiz, San Juan, PR (US); Antonio Jose Roig-Pagan, Ponce, PR (US)

(21) Appl. No.: 14/817,112

(22) Filed: Aug. 3, 2015

Related U.S. Application Data
(63) Continuation-in-part of application No. 14/314,971, filed on Jun. 25, 2014, now Pat. No. 9,099,899.

(51) Int. Cl. H02K 7/18

(52) U.S. Cl. CPC H02K 7/1853

(57) ABSTRACT

A method and apparatus for producing useful work by providing a turnstile preferably located at the entrance of a facility, such as an amusement park, government building and/or train station, regularly visit by pedestrians, wherein said turnstile comprises an actuator including a moveable portion and an energy conversion unit including an energy storage mean, such as a torsion spring. The torsion spring being compressed by the displacement of the moveable portion until an energy release mechanism transfers the stored energy to a generator.

### STATEMENT REGARDING FEDERALLY SPONSORED RESEARCH AND DEVELOPMENT

N/A

### BACKGROUND OF THE INVENTION

1. Field of the Disclosure

The present disclosure relates to a generating system for producing electrical power, and more particularly to an electrical power generating system which utilizes as a source of energy the energy expended by pedestrians moving a turnstile's arm.

2. Discussion of the Background

Methods and apparatuses have been proposed producing useful work for generating electrical current. Generally, conventional forms of energy; e.g., wind, water, solar, nuclear, or steam power produced by burning conventional fuels such as coal, oil and gas have been used to turn the generators for producing electrical power or other work producing machines.

Further a great deal of energy is expended by and thus available from traffic, such as traffic from pedestrians or rolling vehicles. Generally, this energy is not recouped and put to useful purposes because to date, there are no viable devices for efficiently capturing the energy produce by pedestrian. Pedestrian traffic on city streets or at the entrances and/or exits of a facility, such as a government building, train station or amusement park, is considerable, and in view of the growing need of energy, tapping that energy so as to recoup some portion of it is one way to save or redirect available energy.

Therefore there is a need to provide generating system that efficiently utilizes as a source of energy the energy expended by and thus available from traffic, such as traffic from pedestrians or rolling vehicles.

### SUMMARY OF THE DISCLOSURE

The present disclosure provides a system for storing and utilizing the energy expended by pedestrians moving a turnstile's arm. Accordingly, it is an object of the present disclosure to provide a system for generating electricity from pedestrians passing thru a turnstile, wherein the electrical generation system comprises an actuator assembly comprising a first mechanical element, wherein said first mechanical element is mechanically coupled to the actuator, an energy storage mean, wherein said energy storage mean comprises an energy input terminal and an energy output terminal, an energy releasing mechanism, wherein said energy releasing mechanism is mechanically coupled to said energy output terminal; and a rotor of a generator, wherein said rotor is mechanically coupled to the energy output terminal.

Another object of the present disclosure, in accordance with the principle of the present invention, is to provide a method and apparatus for producing electrical energy which is not dependent on the need of fuel such as coal, oil or gas.

It is another object of the present disclosure, in accordance with the principle of the present invention, to provide a method and apparatus for employing the energy generated by moving pedestrian traffic to generate useable electrical energy or useful work.

It is therefore an object of the present disclosure, in accordance with the principle of the present invention, to provide method and apparatus to stored potential energy produced by pedestrian traffic, to generate useable electrical energy or useful work.

Yet another object of the present disclosure, in accordance with the principle of the present invention, is to provide a storage energy system with a release energy valve or system to generate useable electrical energy or useful work.

Still another object of the present disclosure is to provide a sealing mechanism to the apparatus for producing electrical energy.

The disclosure itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

### BRIEF DESCRIPTION OF THE DRAWINGS

The accompanying drawings, which are incorporated herein, constitute part of the specifications and illustrate the preferred embodiment of the disclosure.

FIG. 1 shows an exemplary embodiment of the energy conversion system housing in accordance with the principles of the present disclosure.

FIG. 2 shows an exemplary embodiment of the energy conversion system inner elements connected to the housing in accordance with the principles of the present disclosure.

FIG. 3 shows an exemplary embodiment of the energy conversion system inner elements in accordance with the principles of the present disclosure.

FIG. 4A-4C shows an exemplary embodiment of the actuator in accordance with the principles of the present disclosure.

FIG. 5 shows an exemplary embodiment of the energy conversion unit in accordance with the principles of the present disclosure.

FIG. 6A-6B shows an exemplary embodiment of the energy storage mean of the energy conversion unit in accordance with the principles of the present disclosure.

FIG. 7 shows an exemplary embodiment of the energy releasing mechanism of the energy conversion unit in accordance with the principles of the present disclosure.

FIG. 8 shows an exemplary embodiment of the generator of the energy conversion unit in accordance with the principles of the present disclosure.

### DESCRIPTION OF THE PREFERRED EMBODIMENT

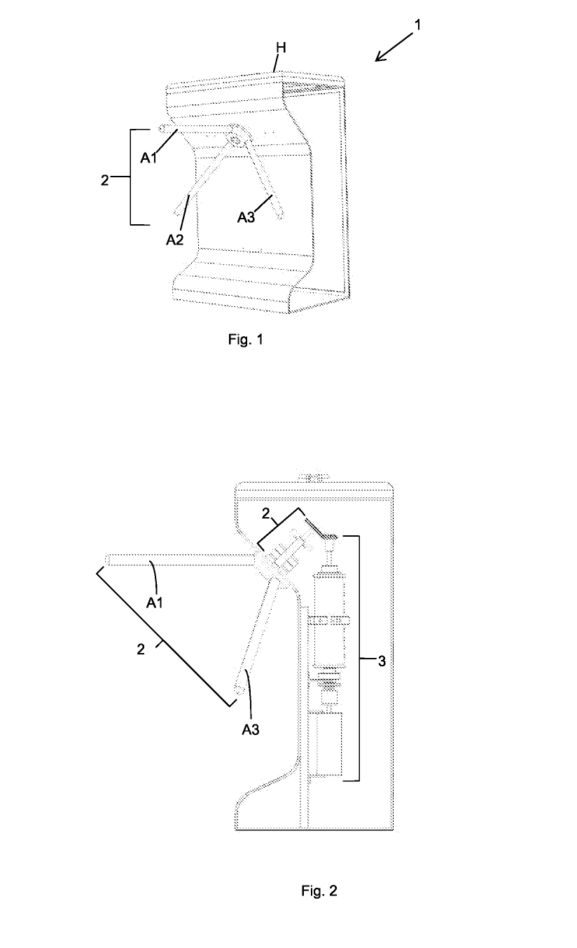

Patent application Ser. No. 14/314,971 is included here by reference. The energy conversion system, in accordance with the principles of the present disclosure, includes a passageway with a turnstile 1 preferably located at the entrance of a facility, such as an amusement park, government building and/or train station, regularly visit by pedestrians. The turnstile 1, as shown in FIG. 1, comprises a housing H, actuator 2 and an energy conversion unit 3. The actuator 2 includes a plurality of horizontal movable bars or blocking arms A1-A3 connected to a hub 11, wherein said movable bar A1-A3 transmits the pedestrians' movement across an entrance to the energy conversion unit 3.

As show in FIG. 2, the turnstile 1, more particularly the blocking arms A1-A3 extend away from the housing H. The turnstile 1 is configured to provide a regulated rotational movement of the blocking arms A1-A3, wherein said blocking arms A1-A3 stops at a stopping position that blocks the passageway for the next pedestrian at the passageway. Preferably, the actuator 2 is configured to rotate with respect to the housing H. The configuration comprises said actuator 2 mounted on said housing H rotating at an angle of approximately 45 (degree) from horizontal with respects to the ground and wherein the blocking arms radiate A1-A3 outwardly from the hub 11. In the instant case the turnstile 1 utilizes three blocking arms A1-A3, one arm is in a substantially horizontal passage stopping position while the remaining arms are in a generally vertical position. The housing H protect part of the actuator 2 and the conversion unit 3, wherein said housing H comprises an outer wall surrounding the energy conversion unit 3. The hub 11 is mechanically coupled to the housing H, by means of a first bearing 150, explained below, which assist the rotation motion of the hub 11 with respects to the housing H. The actuator 2 extends inside the housing H in order to mechanically couple the energy conversion unit 3 by mean of gears, explained below, for transmitting the rotational motion of the hub into the energy storage unit 19 as part of the energy conversion unit 3. Further the energy conversion unit 3 is fixed to the housing H by a platform 20.

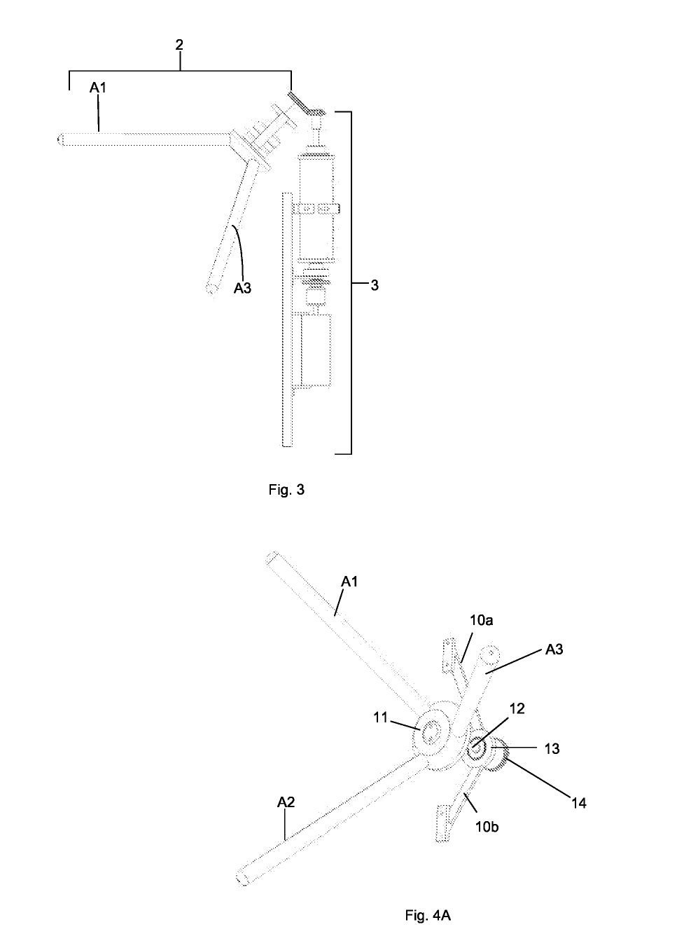

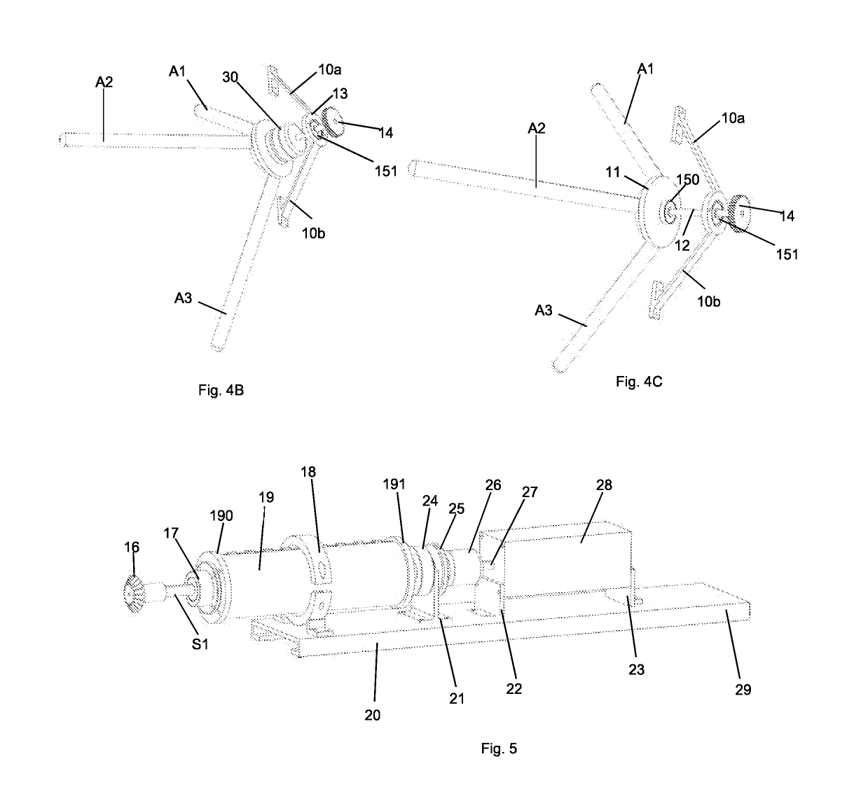

FIG. 3 clearly shows the coupling of the actuator 2 mechanically coupled to the energy conversion unit 3. In the instant case a distal end of the actuator interacts with the pedestrian, for example the plurality blocking arms A1-A3 and the other distal end is mechanically coupled to the energy conversion unit 3. The actuator 2 comprises a plurality blocking arms A1-A3, a hub 11, a first shaft 12, a bearing support 13, bearing supports arms 10a-10b, an unidirectional mechanism 30, a first bearing 150, a second bearing 151 and a first gear 14. As shown in FIG. 4A through 4C the plurality blocking arms A1-A3 are fixed to the hub 11. The first shaft 12 extends from the hub 11 and the first gear is fixed to the distal end of said first shaft 12. The first bearing 150, which surrounds the first shaft 12, is located between the first shaft 12 and the housing H assisting the rotation of the first shaft 12, with respect to the housing H, when the blocking arms A1-A3 is pushed by the pedestrians. A second bearing 151 surrounds the first shaft 12 and is located between the first shaft 12 and a bearing support 13, wherein said bearing support 13 comprises two support bearing arms 10a, 10b. The two support bearing arms 10a, 10b attached the actuator to the housing H and assist with the alignment of said first shaft 12. The actuator 2, more particularly the hub 11 and first shaft 12 are mechanically coupled to an unidirectional mechanism 30 that tolerate rotation of a first shaft 12 in one direction, such as a unidirectional clutch 30.

Further the rotation of the actuator 2 is transferred to the energy conversion unit 3 by means of the first gear 14. The first gear 14 is mechanically coupled to the second gear 16 and the rotations of the first shaft 12 are transferred to the second gear 16 and consequently to the energy storage mean 19. As shown in FIG. 5, the energy storage mean 19 comprises an energy input terminal S1 and an energy output terminal S2, wherein said second gear 16 is mechanically coupled to said energy input terminal S1 and the energy output terminal is coupled to a torque release unit 24 connected to a flywheel 25 and the generator unit 28, wherein said generator unit comprises at least a rotor and a stator. The stator is electrically coupled to the energy output terminal or load B.

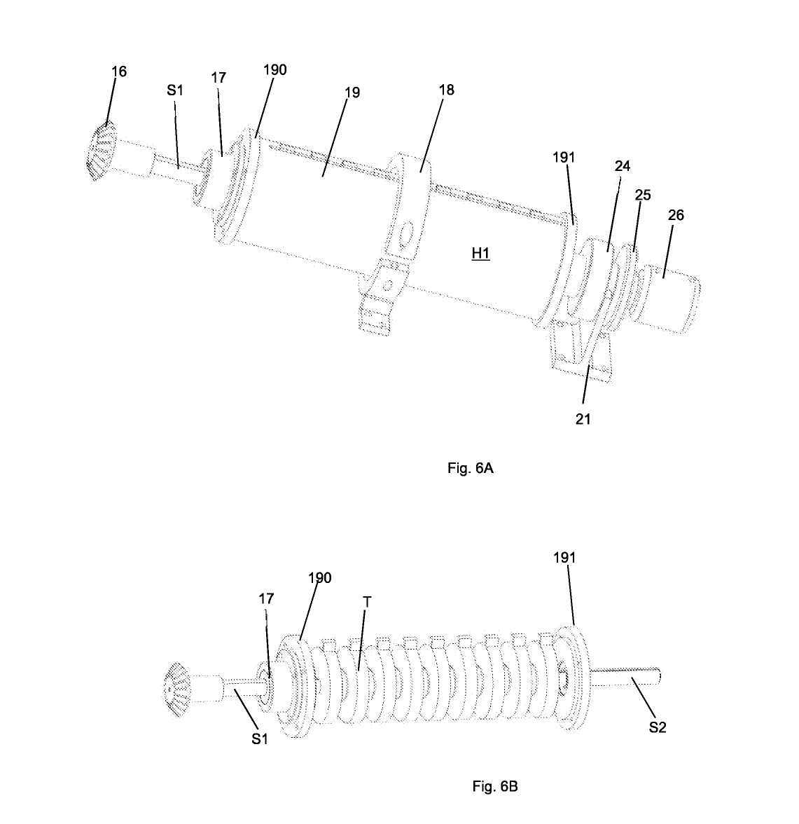

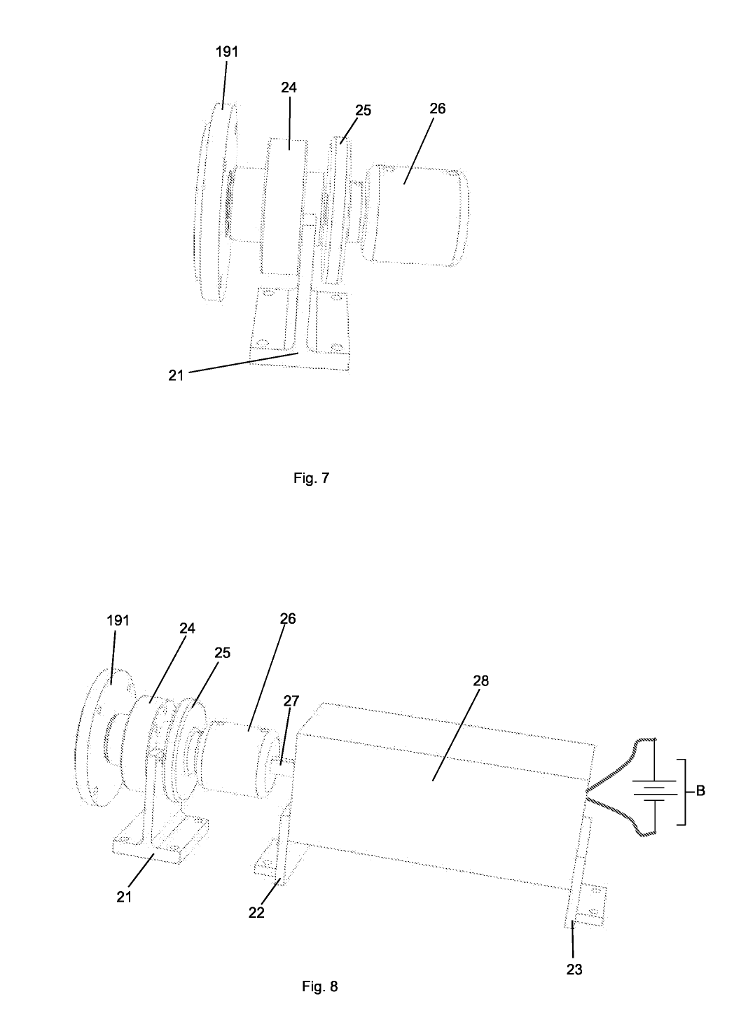

The energy storage mean 19, as shown in FIG. 6A and FIG. 6B, is attached to the platform 20 by means of a first holder 18, wherein said energy storage mean 19 comprises a spring torque T which accumulates energy by torsion or twisting. The spring torque T is twisted by means of the second gear 16 and input terminal S1, which transfers the rotational action from the actuator 2 to the torsion spring T until reaching a designated torque value. Basically the force applied by the pedestrian to the actuator 2 is transmitted to the second gear 16 and input terminal S1 twist or compress the torque spring T at the energy storage mean 19.

The input terminal first shaft 12, comprises a shaft that rotates the inner end of the torsion spring T while the outer end of said torsion spring T, as disclosed in U.S. patent application Ser. No. 14/314,971, included here by reference, is fixed to the energy storage mean 19 housing H1, as result of the first actuator 12, one-way clutch 30 and the input terminal S1, the spring 310 starts to twist and compress. Once the set-up torque value is reached the torque release unit 24 discharges the accumulated potential energy.

FIG. 7 is directed to the mechanical connection between torque release unit 24, energy storage unit 19 and flywheel 25. The torque release unit 24, as mentioned, is supported by a second holder 21 attached to the platform 20 and is configured or set to a predetermined torque value. This pre-determined torque value is proportional to a system which locks the torque release unit 19. As long as the pre-determined torque value of the torque release unit 24 is not reached the output terminal S2 will not be allowed to move. This allows the input terminal S1 to keep accumulating in the torsional spring T. When the pre-determined torque value of the torque release unit 24 is reached, the torque release unit 24 unlocks and allows the output terminal S2, comprising an output shaft, to move freely allowing the accumulated torque from the torsional spring T to be transferred to the flywheel unit 25 and thus the generating unit 28.

The energy released, in form of rotational energy, is transferred to at least a flywheel 25, as shown in FIG. 7 through FIG. 8. Further the flywheel unit 25 works as units to storage, wherein said flywheel rotates at least a mechanical device, such as a rotor, that are used to store rotational energy. Flywheel has a significant moment of inertia, and thus resists changes in rotational speed.

FIG. 8 is directed to the generator 28 assembling. The output terminal S1 is meant to be coupled to the rotor shaft of said generator 28. A magnetic decoupled unit 26, as shown, may be located between the output terminal S1 and generator 28 in case the rotor needs to disengage from the output terminal S1. In the instant case the generator 28 comprises an inner rotor, however it can be connected to an outer rotor.

Although the disclosure has been shown and described with respect to an illustrated embodiment, equivalent alterations and modifications will occur to those skilled in the art upon reading and understanding the specification and the preferred embodiment within the scope of the appended claims.

The disclosure is not limited to the precise configuration described above. While the disclosure has been described as having a preferred design, it is understood that many changes, modifications, variations and other uses and applications of the subject disclosure will, however, become apparent to those skilled in the art without materially departing from the novel teachings and advantages of this disclosure after considering this specification together with the accompanying drawings. Accordingly, all such changes, modifications, variations and other uses and applications which do not depart from the spirit and scope of the disclosure are deemed to be covered by this disclosure as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

What is claimed is:

1. A system for generating electrical power comprising:
a housing,
an actuator comprising a plurality of movable bars, a hub, a first bearing, a first shaft having and a first gear; wherein said plurality of movable bars are coupled to said hub, wherein said hub is mechanically coupled to the housing by means of the first bearing, wherein said first bearing assists the rotational motion of said hub with respect to said housing, wherein said first shaft extends away from said hub, wherein said first shaft comprises a first distal end; and wherein said first gear is coupled to said first shaft; and
an energy conversion unit comprising an energy storage means, wherein said energy storage means comprises an energy input terminal and an energy output terminal, wherein said first actuator is mechanically coupled to said energy input terminal; and
a rotor of a generator, wherein said rotor is mechanically coupled to the energy output terminal.

2. The system for generating electricity, as in claim 1 comprising;
a torque release unit, wherein said torque release unit is mechanically positioned between the energy output terminal and an said rotor.

3. The system for generating electricity, as in claim 1; wherein an unidirectional mechanism is mechanically coupled between said hub and said housing.

4. The system for generating electricity from vehicle motion, as in claim 1; wherein said energy storage means comprises a torsion spring.

5. A system for generating electricity comprising;
a housing,
a first actuator, wherein said first actuator is mechanically coupled to said housing and wherein said actuator is configured to rotate with respect to said housing generating at least a first rotational motion;
an energy storage means, wherein said energy storage means comprises an energy input terminal and an energy output terminal, wherein said first actuator is mechanically coupled to said energy input terminal for transmitting said first rotational motion to said energy storage means;
an energy release unit, wherein said energy release unit is mechanically positioned between the energy output terminal and an generator;
and wherein said energy release unit limits a second rotational motion of said energy output terminal.

6. The system for generating electricity, as in claim 5;
wherein said energy storage mean comprises at least a torsion spring.

7. A system for generating electricity, as in claim 5;
wherein said energy release unit is a torque release unit, wherein said torque release unit measures the energy stored in the energy storage means an compares a measured energy stored value with an energy selected value.
